(19) United States
(12) Patent Application Publication
(10) Pub. No.: US 2019/0179694 A1
(43) Pub. Date: Jun. 13, 2019

(54) DATA STORAGE DEVICE, OPERATING METHOD THEREOF AND STORAGE SYSTEM INCLUDING THE SAME

(71) Applicant: SK hynix Inc., Gyeonggi-do (KR)

(72) Inventor: Jeen PARK, Gyeonggi-do (KR)

(21) Appl. No.: 15/946,186

(22) Filed: Apr. 5, 2018

(30) Foreign Application Priority Data
Dec. 7, 2017 (KR) 10-2017-0167249

(51) Int. Cl. G06F 11/07; G06F 3/06

(52) U.S. Cl. CPC G06F 11/0787; G06F 11/0727; G06F 3/0679; G06F 3/0656; G06F 3/0659; G06F 3/0619

(57) ABSTRACT

A data storage device includes a nonvolatile memory device; and a controller suitable for programming data to the nonvolatile memory device or reading out data from the nonvolatile memory device, wherein the controller is configured to include a debugging data management circuit suitable for storing, in a first storage space, debugging data obtained by collecting an information at an occurrence time of an error as the error occurs during an operation of the controller and copying the debugging data of the first storage space to a second storage space as a debugging data copy event occurs.

### CROSS-REFERENCES TO RELATED APPLICATION

The present application claims priority under 35 U.S.C. § 119(a) to Korean application number 10-2017-0167249, filed on Dec. 7, 2017, which is incorporated herein by reference in its entirety.

### BACKGROUND

### 1. Technical Field

Various exemplary embodiments generally relate to a semiconductor integrated device. Particularly, the embodiments relate to a data storage device, an operating method thereof, and a storage system including the same.

### 2. Related Art

With the development of semiconductor, electronic, and communication technologies, the performance of storage media improving day by day. That is, storage media is moving towards having high capacity, high integration, miniaturization, high performance, and high speed, and firmware may be configured in such a manner that storage media can include various functions.

However, an increase in the operation speed of a storage medium and its various functions may cause and increase errors therein. Therefore, a debugging technique for detecting and correcting an error likely to occur while the storage medium operates is needed.

A storage medium may often be realized in the form of an embedded system. The embedded system may be an electronic control system in which computer hardware and software are combined to perform predetermined functions. In the embedded system, an operating system's core software module may be configured to manage all the resources of the embedded system. For example, the software module may perform interrupt processing, process management, memory management, and file system management. In particular, the software module may detect whether a process abnormally operates due to a design error or an external influence, and may terminate the process when an abnormal operation is detected. Further, in order to correct the abnormal operation, the software module may generate a file including informations necessary for debugging, so that a designer may trace the cause of the abnormal operation of the process.

As such, generating data related to an unexpected error caused by a problem in hardware, software, or firmware during the operation of the storage medium and performing debugging based on the generated data may be regarded as a procedure that is essential to improve the performance of the storage medium. Thus, it is desirable to secure debugging data for an error situation that may occur during operation of the storage medium, and to apply the data for debugging.

### SUMMARY

In an embodiment, a data storage device may include: a nonvolatile memory device; a controller suitable for programming data to the nonvolatile memory device or reading out data from the nonvolatile memory device, wherein the controller includes a debugging data management circuit suitable for storing, in a first storage space, debugging data obtained by collecting an information when an error occurs during an operation of the controller and copying the debugging data of the first storage space to a second storage space when a debugging data copy event occurs.

In an embodiment, a data storage device may include a nonvolatile memory device and a controller which controls data exchange with the nonvolatile memory device, the controller comprising: a detecting section suitable for detecting whether a process executed in the data storage device is abnormally terminated; a collecting section suitable for storing, in a first storage space, debugging data obtained by collecting a log at a time when an error has occurred, when it is detected that the process is abnormally terminated; a scheduling section suitable for allocating a second storage space when a debugging data copy event occurs; and a copying section suitable for copying the debugging data stored in the first storage space to the second storage space.

In an embodiment, a method for operating a data storage device including a nonvolatile memory device and a controller which controls data exchange with the nonvolatile memory device may include: detecting an error situation, by the controller, when a process executed in the data storage device is abnormally terminated; storing, in a first storage space, debugging data obtained by collecting a log at a time when an error has occurred, by the controller; allocating a second storage space, by the controller, when a debugging data copy event occurs; and copying the debugging data stored in the first storage space to the second storage space, by the controller.

In an embodiment, a storage system may include: a host device; and a data processing device including a nonvolatile memory device and a controller suitable for programming data to the nonvolatile memory device or reading out data from the nonvolatile memory device in response to a request of the host device, wherein the controller stores, in a first storage space, debugging data obtained by collecting an information when an error occurs during an operation of the controller and copy the debugging data of the first storage space to a second storage space when a debugging data copy event occurs.

According to the present technology, a precise debugging operation may be performed by maximally securing debugging data and applying them to debugging.

### BRIEF DESCRIPTION OF THE DRAWINGS

FIG. 1 is a configuration diagram illustrating a data storage device in accordance with an embodiment of the present disclosure.

FIG. 2 is a configuration diagram illustrating a controller of FIG. 1 in accordance with an embodiment of the present disclosure.

FIG. 3 is a configuration diagram illustrating a debugging data management circuit of FIG. 1 in accordance with an embodiment of the present disclosure.

FIG. 4 is a flow chart describing a method for operating a data storage device in accordance with an embodiment of the present disclosure.

FIG. 5 is a diagram illustrating a data processing system including a solid state drive (SSD) in accordance with an embodiment of the present disclosure.

FIG. 6 is a diagram illustrating a data processing system including a memory system in accordance with an embodiment of the present disclosure.

FIG. 7 is a diagram illustrating a data processing system including a memory system in accordance with an embodiment of the present disclosure.

FIG. 8 is a diagram illustrating a network system including a memory system in accordance with an embodiment of the present disclosure.

FIG. 9 is a block diagram illustrating a nonvolatile memory device included in a memory system in accordance with an embodiment of the present disclosure.

### DETAILED DESCRIPTION

Various embodiments of the present invention are described below in more detail with reference to the accompanying drawings. We note, however, that the present invention may be embodied in different forms and variations, and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

Hereinafter, a data storage device, an operating method thereof and a storage system including the same will be described below with reference to the accompanying drawings through various examples of embodiments.

FIG. 1 is a configuration diagram illustrating a data storage device 10 in accordance with an embodiment of the present disclosure.

Referring to FIG. 1, the data storage device 10 may include a controller 110 and a nonvolatile memory device (NVM) 120.

The controller 110 may control the nonvolatile memory device 120 in response to a request of a host device or a host processor. For example, the controller 110 may cause the data provided according to a program request of the host device, to be programmed in the nonvolatile memory device 120. Also, the controller 110 may provide the host device with the data stored in the nonvolatile memory device 120 in response to a read request of the host device.

The nonvolatile memory device 120 may write data or output written data according to the control of the controller 110. The nonvolatile memory device 120 may be implemented using a memory device selected among various nonvolatile memory devices such as an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM). The nonvolatile memory device 120 may include a plurality of dies, a plurality of chips, or a plurality of packages. Furthermore, the nonvolatile memory device 120 may be comprised of single level cells each storing 1 bit of data or multi-level cells each storing a plurality of bits of data.

In an embodiment, the controller 110 may include a debugging data management circuit 20. If an error occurs in the hardware, software, or firmware of the data storage device 10 while the data storage device 10 performs a series of operations such as programming and reading data by cooperating with the host device, the debugging data management circuit 20 may collect informations at the time when the error has occurred and may store debugging data, which represents the error of the hardware, software, or firmware of the data storage device 10, in a first storage space allocated in the controller 110. Then, if an event that causes debugging data to be copied occurs, the debugging data management circuit 20 may copy the debugging data from the first storage space to a second storage space allocated in the controller 110.

In an embodiment, the first storage space may be a dedicated debugging data storage space, which is allocated in the controller 110 to primarily store debugging data. In the case where the capacity of the first storage space is insufficient, the first storage space cannot store debugging data beyond the capacity of the first storage space. Therefore, in the case where the remaining capacity of the first storage space is equal to or smaller than predetermined threshold or if a predefined debugging data copy event such as an elapse of a predetermined cycle occurs, the debugging data management circuit 20 may copy the debugging data stored in the first storage space to the second storage space. The second storage space may be, for example, a region used as an input/output (IO) buffer for temporarily storing data to be transmitted and received between the host device and the nonvolatile memory device 120, but it is to be noted that the embodiment is not limited thereto. Copying the debugging data into the second storage space having a sufficient capacity, such as the IO buffer, may secure a sufficient error history during the operation of the data storage device 10, so that a more accurate and precise debugging operation can be performed.

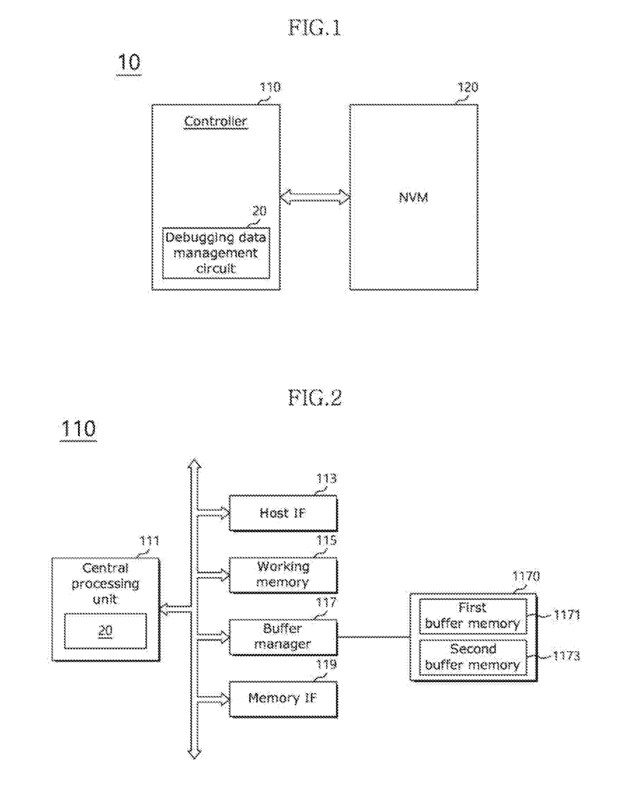

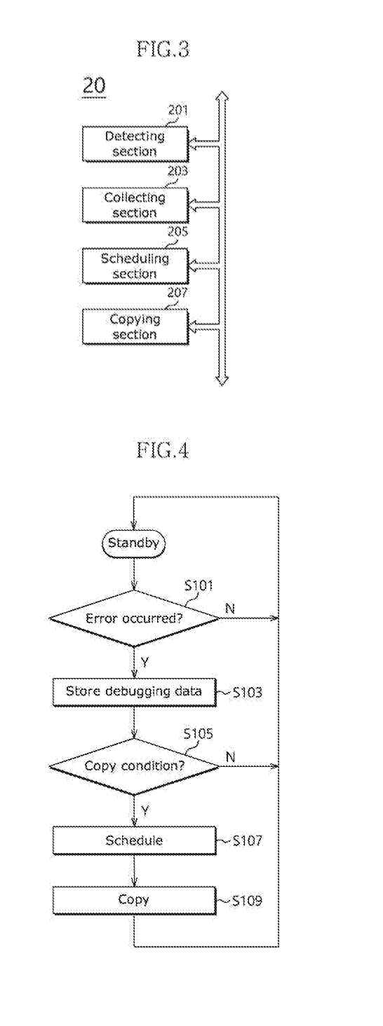

FIG. 2 is a configuration diagram illustrating the controller 110 of FIG. 1 in accordance with an embodiment of the present disclosure.

Referring to FIG. 2, the controller 110 may include a central processing unit 111, a host interface 113, a working memory 115, a buffer manager 117, and a memory interface (IF) 119.

The central processing unit 111 may transfer various control informations necessary for a data read or program operation for the nonvolatile memory device 120 to the host interface 113, the working memory 115, the buffer manager 117, and the memory interface 119. In an embodiment, the central processing unit 111 may operate depending on firmware provided for various operations of the data storage device 10. In an embodiment, the central processing unit 111 may execute a flash translation layer (FTL) for performing garbage collection, address mapping, wear leveling, and so forth to manage the nonvolatile memory device 120. In an embodiment, the central processing unit 111 may also detect and correct the error of the data read out from the nonvolatile memory device 120.

The host interface 113 may provide a communication channel for receiving a command and a clock signal from the host device (host processor) and controlling input/output of data, according to the control of the central processing unit 111. In particular, the host interface 113 may provide a physical coupling between the host device and the data storage device 10. Further, the host interface 113 may provide interfacing with the data storage device 10 in correspondence to the bus format of the host device. The bus format of the host device may include at least any one among standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E), and universal flash storage (UFS).

The working memory 115 may store program codes necessary for the operation of the controller 110, such as firmware or software, and may store code data used by the program codes.

The buffer manager 117 may temporarily store data to be transmitted and stored between the host device and the nonvolatile memory device 120 in a program operation or a read operation, in a buffer memory 1170.

The buffer memory 1170 may include a region which operates as the input/output buffer of the nonvolatile memory device 120, and may include a first buffer memory 1771 and a second buffer memory 1173. In an embodiment, the first buffer memory 1171 may be configured by a volatile memory and the second buffer memory 1173 may be configured by a nonvolatile memory, but it is to be noted that the embodiment is not limited thereto. In an embodiment, the buffer memory 1170 may include an SRAM and/or a DRAM.

While FIG. 2 illustrates as an example a case where the buffer memory 1170 is positioned inside the controller 110, it is to be noted that the present disclosure is not limited thereto. That is, the buffer memory 1170 may be positioned outside the controller 110 and be managed by the buffer manager 117.

The memory interface 119 may provide a communication channel for transmission and reception of signals between the controller 110 and the nonvolatile memory device 120. The memory interface 119 may write the data temporarily stored in the buffer memory 1170, in the nonvolatile memory device 120, according to the control of the central processing unit 111. Moreover, the memory interface 119 may transfer and temporarily store the data read out from the nonvolatile memory device 120, to and in the buffer memory 1170.

In an embodiment, debugging data may be stored in the predetermined first storage space of the buffer memory 1170, such as a predefined dedicated debugging data storage space between the first buffer memory 1171 and the second buffer memory 1173, by the control of the debugging data management circuit 20. The debugging data management circuit 20 may copy the debugging data stored in the first storage space to the predetermined second storage space of the buffer memory 1170 when a debugging data copy event occurs.

FIG. 3 is a configuration diagram illustrating the debugging data management circuit 20 of FIG. 1 in accordance with an embodiment of the present disclosure.

Referring to FIG. 3, the debugging data management circuit 20 may include a detecting section 201, a collecting section 203, a scheduling section 205, and a copying section 207.

The detecting section 201 may detect whether the process of the controller 110 is abnormally terminated while being executed in the data storage device 10. If it is detected that the process of the controller 110 is abnormally terminated, that is, when it is detected that an error occurs in the hardware, software, or firmware of the data storage device 10, the detecting section 201 may notify the collecting section 203 of the abnormal termination, that is, of the error of the hardware, software, or firmware of the data storage device 10.

As a signal which notifies the abnormal termination of the process is received from the detecting section 201, the collecting section 203 may collect an error log including process-related information representing the abnormally terminated process, that is, information of the error at the time when an error has occurred.

Debugging data may be a collection of the process-related information or the information of the errors of the hardware, software, or firmware of the data storage device 10, and may be stored in the predetermined first storage space. In an embodiment, the first storage space may be a dedicated storage space which is allocated in the buffer memory 1170 to store debugging data. The debugging data stored in the first storage space may be managed in a scheme in which only recently stored data are retained due to a limitation in the storage capacity allocated to the first storage space, for example, a least recently used (LRU) eviction algorithm. Therefore, oldest debugging data may be lost in the first storage space according to the LRU eviction algorithm. Therefore in the present technology, before the debugging information stored in the first storage space is lost, it is copied to another storage space such that it may be used for debugging.

The scheduling section 205 may be configured to allocate the second storage space to which the debugging data stored in the first storage space are to be copied as a debugging data copy event occurs. The scheduling section 205 may allocate a space of predetermined capacity in the unused region of the buffer memory 1170 as a copy region. In an embodiment, the scheduling section 205 may allocate, as the second storage space, a region of the buffer memory 1170 which is most recently released and has a low possibility to lose data for a while.

In an embodiment, the scheduling section 205 may allocate, as the second storage space, a region which is most recently released in the IO buffer region of the buffer memory 1170, but it is to be noted that the embodiment is not limited thereto.

A debugging data copy event may be activated before the debugging information stored in the first storage space is lost, and may be set as a condition such as a case where the remaining capacity of the first storage space is equal to or smaller than the predetermined threshold or when a predetermined time cycle has elapsed.

The copying section 207 may copy the debugging data stored in the first storage space to the second storage space when a debugging data copy event occurs, and thus the second storage space is allocated by the scheduling section 205. The copying section 207 may be implemented in the form of a hardware logic (a copy engine) such that a latency for copying debugging data may be minimized.

Further, the copying section 207 may copy debugging data to the second storage space by adding identification information (e.g., a serial number) representing a sequence of copying the debugging data and an information, for example, a checksum for checking the reliability of the debugging data.

When the second storage space is allocated as a portion of the IO buffer and debugging data are copied to the second storage space, when a failure occurs in the data storage device 10 and a dump command is executed, all the debugging data copied to the second storage space are dumped together and thus the maintenance and management efficiency of the debugging data may be increased.

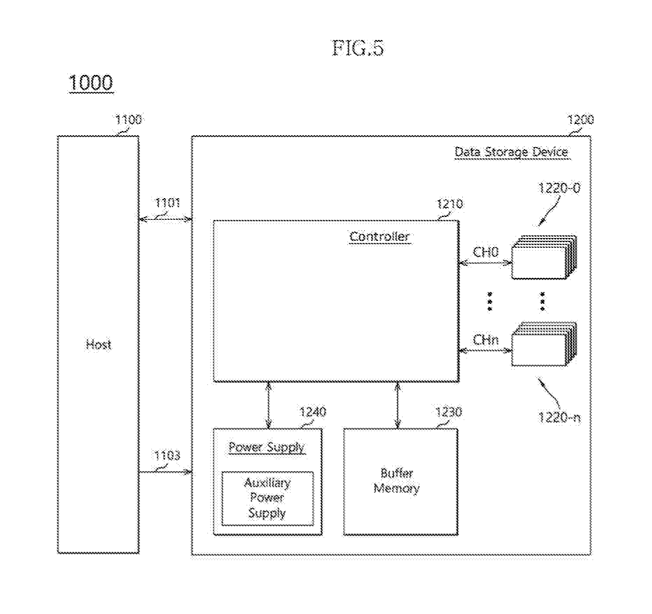

FIG. 4 is a flow chart describing a method for operating a data storage device in accordance with an embodiment of the present disclosure.

At step S101, if an error occurs while a process is executed as the data storage device 10 operates according to the control of the controller 110 and thereby the process is abnormally terminated, the debugging data management circuit 20 may detect the abnormal termination as an error of the hardware, software, or firmware of the data storage device 10.

If an error is detected, the debugging data management circuit 20 may collect an error log including process-related information representing the abnormally terminated process, that is, information of the error at the time when the error has occurred, and store the error log as debugging data in the predetermined first storage space, at step S103. Debugging data may be a collection of the process-related information or the information of the errors of the hardware, software or firmware of the data storage device 10. In an embodiment, the first storage space may be a dedicated storage space which is allocated in the buffer memory 1170 to store the debugging data.

The debugging data management circuit 20 may monitor whether a debugging data copy event occurs at step S105, and may allocate the second storage space for copying the debugging data stored in the first storage space when a debugging data copy event occurs, at step S107.

In an embodiment, the debugging data management circuit 20 may allocate, as the second storage space, a region of the buffer memory 1170 which is most recently released and has a low possibility of losing data for a while.

Then, the debugging data management circuit 20 may copy the debugging data of the first storage space, to the second storage space allocated at the step S107 at step S109. Copying of the debugging data may be performed by a hardware logic, that is, a copy function module implemented in the form of a copy engine to minimize an operation latency.

Accordingly, the debugging data stored in the first storage space may be copied to the second storage space before they are lost, and may be used in a subsequent debugging operation so that precise debugging may be performed.

FIG. 5 is a diagram illustrating a data processing system 1000 including a solid state drive (SSD) 1200 in accordance with an embodiment of the present disclosure. Referring to FIG. 5, the data processing system 1000 may include a host device 1100 and the SSD 1200.

The SSD 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the SSD 1200. The controller 1210 may include a host interface unit, a control unit, a random access memory used as a working memory, an error correction code (KC) unit, and a memory interface unit. In an embodiment, the controller 1210 may configured by controller 110 comprising debugging data management circuit 20 as shown is FIG. 1 to FIG. 3.

The host device 1100 may exchange a signal with the SSD 1200 through the signal connector 1101. The signal may include a command, an address, data, and so forth. The host interface unit 1211 may interface the host device 1100 and the SSD 1200 according to the protocol of the host device 1100.

The controller 1210 may analyze and process the signal received from the host device 1100. The controller 1210 may control operations of internal function blocks according to a firmware or a software for driving the SSD 1200.

The ECC unit may detect an error of the data read from at least one of the nonvolatile memory devices 1220-0 to 1220-n. If a detected error is within a correctable range, the ECC unit may correct the detected error.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the SSD 1200. The nonvolatile memory devices 1220-0 to 1220-n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1103, to the inside of the SSD 1200. The power supply 1240 may include an auxiliary power supply. The auxiliary power supply may supply power to allow the SSD 1200 to be normally terminated when a sudden power-off occurs. The auxiliary power supply may include large capacity capacitors.

The signal connector 1101 may be configured by various types of connectors depending on an interface scheme between the host device 1100 and the SSD 1200.

The power connector 1103 may be configured by various types of connectors depending on a power supply scheme of the host device 1100.

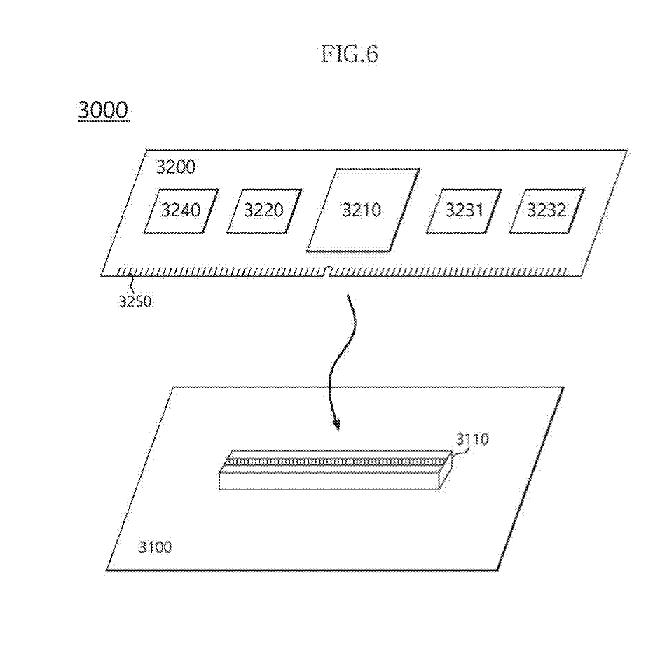

FIG. 6 is a diagram illustrating a data processing system 3000. Referring to FIG. 6, the data processing system 3000 may include a host device 3100 and the memory system 3200.

The host device 3100 may be configured in the form of a board such as a printed circuit board. Although not shown, the host device 3100 may include internal function blocks for performing the function of a host device.

The host device 3100 may include a connection terminal 3110 such as a socket, a slot or a connector. The memory system 3200 may be mounted to the connection terminal 3110.

The memory system 3200 may be configured in the form of a board such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 comprising the debugging data management circuit 20 as shown in FIGS. 2 and 3.

The buffer memory device 3220 may temporarily store data to be stored in the nonvolatile memory devices 3231 and 3232. Further, the buffer memory device 3220 may temporarily store the data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250, to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data and so forth and power may be transferred between the host device 3100 and the memory system 3200. The connection terminal 3250 may be configured into various types depending on an interface scheme between the host device 3100 and the memory system 3200. The connection terminal 3250 may be disposed on any one side of the memory system 3200.

FIG. 7 is a diagram illustrating a data processing system 4000 including a memory system 4200 in accordance with an embodiment of the present disclosure. Referring to FIG. 7, the data processing system 4000 may include a host device 4100 and the memory system 4200.

The host device 4100 may be configured in the form of a board such as a printed circuit board. Although not shown, the host device 4100 may include internal function blocks for performing the function of a host device.

The memory system 4200 may be configured in the form of a surface-mounting type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 comprising the debugging data management circuit 20 as shown in FIGS. 2 and 3.

The buffer memory device 4220 may temporarily store data to be stored in the nonvolatile memory device 4230. Further, the buffer memory device 4220 may temporarily store the data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

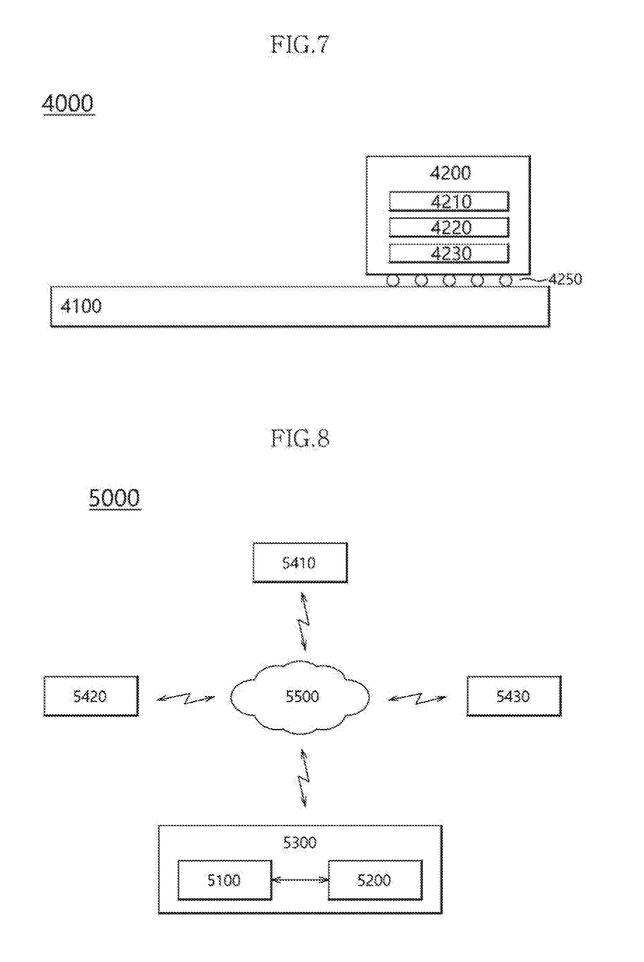

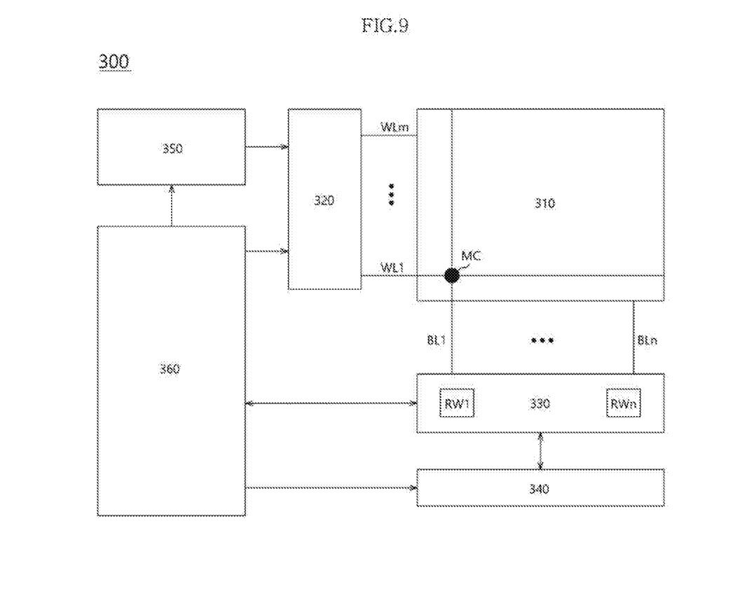

FIG. 8 is a diagram illustrating a network system 5000 including a memory system 5200 in accordance with an embodiment of the present disclosure. Referring to FIG. 8, the network system 5000 may include a server system 5300 and a plurality of client systems 5410 to 5430 which are coupled through a network 5500.

The server system 5300 may service data in response to requests from the plurality of client systems 5410 to 5430. For example, the server system 5300 may store the data provided from the plurality of client systems 5410 to 5430. For another example, the server system 5300 may provide data to the plurality of client systems 5410 to 5430.

The server system 5300 may include a host device 5100 and the memory system 5200. The memory system 5200 may be configured by the memory system 10 shown in FIG. 1, the SSD 1200 shown in FIG. 5, the memory system 3200 shown in FIG. 6 or the memory system 4200 shown in FIG. 7.

FIG. 9 is a block diagram illustrating a nonvolatile memory device 300 included in a memory system in accordance with an embodiment of the present disclosure. Referring to FIG. 9, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array has a direction perpendicular to the flat surface of a semiconductor substrate. Moreover, the three-dimensional memory array means a structure including NAND strings which at least memory cell is located in a vertical upper portion of the other memory cell.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

While various embodiments have been described above, it will be understood to those skilled in the art that the embodiments described mere examples. Accordingly, the data storage device, the operating method thereof, and the storage system including the same described herein should not be limited based on the described embodiments.

What is claimed is:

1. A data storage device comprising:
a nonvolatile memory device; and
a controller suitable for programming data to the nonvolatile memory device or reading out data from the nonvolatile memory device,
wherein the controller includes a debugging data management circuit suitable for storing, in a first storage space, debugging data obtained by collecting an information when an error occurs during an operation of the controller and copying the debugging data of the first storage space to a second storage space when a debugging data copy event occurs.

2. The data storage device according to claim 1, further comprising:
an input/output buffer suitable for temporarily storing data to be programmed to the nonvolatile memory device or data read out from the nonvolatile memory device,
wherein the debugging data management circuit allocates a portion of the input/output buffer as the second storage space when the debugging data copy event occurs.

3. The data storage device according to claim 1, wherein the debugging data management circuit comprises a hardware logic which performs the copying.

4. The data storage device according to claim 1, wherein the debugging data management circuit is configured to add an identification information capable of identifying a copy sequence of the debugging data.

5. The data storage device according to claim 1, wherein the debugging data management circuit is configured to add an information capable of checking reliability of the debugging data.

6. The data storage device according to claim 1, wherein the debugging data copy event occurs in a case where a remaining capacity of the first storage space is equal to or smaller than a predetermined capacity or a case where a predetermined time cycle has elapsed.

7. The storage system according to claim 1, wherein the controller operates the first storage space according to a least recently used (LRU) eviction algorithm.

8. A data storage device including a nonvolatile memory device and a controller which controls data exchange with the nonvolatile memory device, the controller comprising:
a detecting section suitable for detecting whether a process executed in the data storage device is abnormally terminated;
a collecting section suitable for storing, in a first storage space, debugging data obtained by collecting a log at a time when an error has occurred, when it is detected that the process is abnormally terminated;
a scheduling section suitable for allocating a second storage space when a debugging data copy event occurs; and
a copying section suitable for copying the debugging data stored in the first storage space to the second storage space.

9. The data storage device according to claim 8, further comprising:
an input/output buffer suitable for temporarily storing data to be programmed to the nonvolatile memory device or data read out from the nonvolatile memory device,
wherein the scheduling section allocates a portion of the input/output buffer as the second storage space.

10. The data storage device according to claim 8, wherein the copying section comprises a hardware logic.

11. The data storage device according to claim 8, wherein the copying section is configured to add an identification information capable of identifying a copy sequence of the debugging data.

12. The data storage device according to claim 8, wherein the copying section is configured to add an information capable of checking reliability of the debugging data.

13. The data storage device according to claim 8, wherein the debugging data copy event occurs in a case where a remaining capacity of the first storage space is equal to or smaller than a predetermined capacity or a case where a predetermined time cycle has elapsed.

14. The storage system according to claim 8, wherein the controller operates the first storage space according to a least recently used (LRU) eviction algorithm.

15. A method for operating a data storage device including a nonvolatile memory device and a controller which controls data exchange with the nonvolatile memory device, the method comprising:
detecting an error situation, by the controller, when a process executed in the data storage device is abnormally terminated;
storing, in a first storage space, debugging data obtained by collecting a log at a time when an error has occurred, by the controller;
allocating a second storage space, by the controller, when a debugging data copy event occurs; and
copying the debugging data stored in the first storage space to the second storage space, by the controller.

16. The method according to claim 15,
wherein the data storage device further includes an input/output buffer suitable for temporarily storing data to be programmed to the nonvolatile memory device or data read out from the nonvolatile memory device, and
wherein the allocating of the second storage space comprises allocating a portion of the input/output buffer as the second storage space, by the controller.

17. The method according to claim 15, wherein the copying further comprises adding an identification information capable of identifying a copy sequence of the debugging data.

18. The method according to claim 15, wherein the copying further comprises adding an information capable of checking reliability of the debugging data.

19. The method according to claim 15, wherein the debugging data copy event occurs in a case where a remaining capacity of the first storage space is equal to or smaller than a predetermined capacity or a case where a predetermined time cycle has elapsed.

20. The storage system according to claim 15, wherein the controller operates the first memory space according to a least recently used (LRU) eviction algorithm.
